(19) United States
(12) Patent Application Publication
(10) Pub. No.: US 2007/0227562 A1
(43) Pub. Date: Oct. 4, 2007

(54) Apparatus and methods for treating substrates

(76) Inventors: Sung-Hee Lee, Cheonan-si (KR); Myung-Jin Lee, Cheonan-si (KR)

Correspondence Address: HARNESS, DICKEY & PIERCE, P.L.C., P.O. BOX 8910, RESTON, VA, 20195, US

(21) Appl. No.: 11/655,183

(22) Filed: Jan. 19, 2007

(30) Foreign Application Priority Data
Mar. 31, 2006 (KR) 10-2006-0029582

(51) Int. Cl. B08B 3/00; B08B 3/12

(52) U.S. Cl. 134/34; 134/198; 134/184; 134/61

(57) ABSTRACT

This invention is related to an apparatus for treating substrates. According to the present invention, the substrate is cleaned by injecting high temperature and high pressure steam on substrate. A steam generator is configured to continually provide steam on substrate. After cleaning by steam, cleaning by brush may be followed.

### CROSS-REFERENCE TO RELATED APPLICATIONS

This U. S non-provisional patent application claims priority under 35 U.S.C §119 of Korean Patent Application 2006-29582 filed on Mar. 31, 2006, the entirety of which is hereby incorporated by reference.

### BACKGROUND ART

The present invention relates to apparatus and methods for treating substrates. More specifically, the present invention is directed to apparatus and methods for cleaning substrates used to manufacture wafers or flat panel display devices.

Recently, data processing apparatus are rapidly developing with various types of functions and higher data processing speed. Such data processing apparatus have display panel that indicate operating information. Conventionally cathode ray tube monitors were widely used for display panels, however due to rapid technology development, use of flat panel display such as LCD which is light in weight and occupies less space is rapidly increasing.

Various processes are required to manufacture flat panel display. Cleaning process among these various processes is to clean contaminants such as particles adhered on substrates. This cleaning process is done to increase yield by minimizing loss of components such as thin layer transistor. Generally cleaning process is to remove contaminants from substrates by applying water to substrates or to remove contaminants from substrates physically by using brush. In case the cleaning process is done by using brush, large-sized particles over tens of micrometers are usually removed easily from substrates but micro-particles of few nanometers are not easily removed from substrates.

In case the cleaning process is done by applying water on substrates, large amount of water may be required for cleaning larger size of substrates. Substrate cleaning effectiveness may be increased when the water is injected directly onto substrates at a high temperature and a high pressure. However, when cleaning process is done by injecting water onto substrates, it is difficult to provide heater for heating large amounts of water required in cleaning large substrates. Also, even when cleaning substrates by applying water, fine particles under few micrometers are not easily removed from substrates than when cleaning substrates by using brush.

### SUMMARY OF THE INVENTION

Exemplary embodiments of the present invention are directed to an apparatus and method for treating substrates. In an exemplary embodiment, the apparatus may include an apparatus for treating substrates comprising: a chamber having a space in which process is performed and substrate is accommodated; a steam cleaning member configured to clean by supplying steam to the substrate disposed in the chamber, wherein the steam cleaning member comprises: a steam generator generating steam from cleaning liquid; a steam nozzle provided in the chamber, which injects directly the steam generated from the steam generator to the substrate.

In another exemplary embodiment, the apparatus may include an apparatus for treating substrates comprising: a moving unit moving substrates in a straight line; a cleaning unit configured to clean substrates being moved by the moving unit, wherein the cleaning unit comprises: a steam cleaning member having steam nozzle configured to supply steam to the substrate, the steam cleaning member configured to clean the substrate by steam; a brush cleaning member having a brush configured to clean the region on the substrate where steam cleaning has been performed.

In an exemplary embodiment, the method may include a method for treating substrates wherein, a steam nozzle is disposed on top or bottom of the substrate, the steam nozzle configured to inject steam directly to the substrate in a length corresponding to a side of the substrate, and the substrate or the steam nozzle is moved in a straight line so that cleaning may be performed from first line to other lines successively in the substrate.

In another exemplary embodiment, the method may include a method for treating substrates wherein, steam is injected to the substrate to weaken adhesion of impurities on the substrates which the impurities are removed from the substrate by using brush.

### BRIEF DESCRIPTION OF THE DRAWINGS

FIG. 1 illustrates a cross-sectional view of an apparatus for treating substrate according to a preferred embodiment of the present invention.

FIG. 2 illustrates a plan view of the apparatus for treating substrate of FIG. 1.

FIG. 3a and FIG. 3b illustrate front views of examples of nozzle of FIG. 1, respectively.

FIG. 4a and FIG. 4b illustrate cross-sectional views of examples of nozzle of FIG. 1, respectively.

FIG. 5 illustrates a simplified view of the steam generating member.

FIG. 6 illustrates a flow-chart showing sequential substrate cleaning method using the device in FIG. 1.

FIG. 7 illustrates briefly the substrate cleaning process using steam illustrated in FIG. 1.

FIG. 8 and FIG. 9 illustrate other examples of device in FIG. 1, respectively.

### DETAILED DESCRIPTION OF PREFERRED EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art.

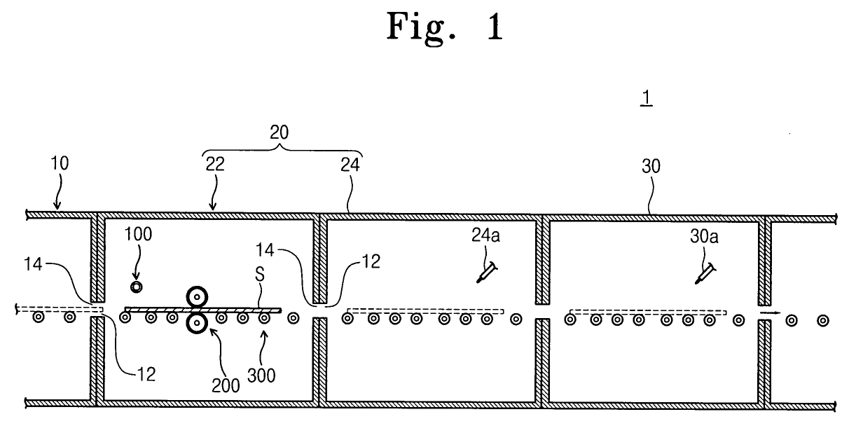

This will now be described below with reference to the accompanying drawings from FIG. 1 to FIG. 9. Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

In the present invention, a substrate S used in fabricating flat panel display is picked as an example to explain the present invention. However, the substrate S may also be a wafer used in fabricating semiconductor chip.

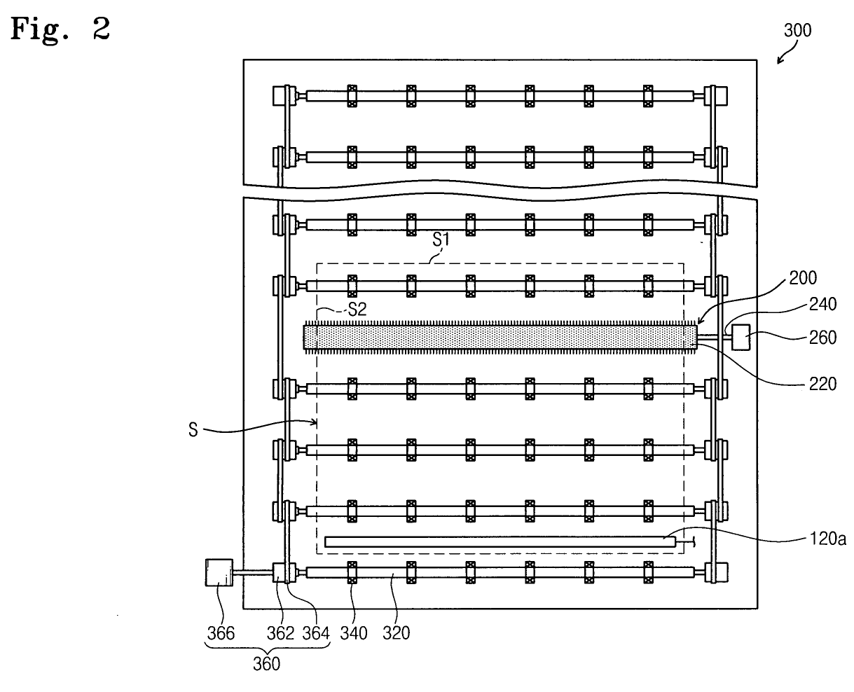

FIG. 1 illustrates an apparatus for treating substrates 1 according to a preferred embodiment of the present invention. FIG. 2 illustrates a plane view of inside of cleaning chamber 22 among the chambers 10, 22, 24, 30 of FIG. 1. Referring to FIG. 1 and FIG. 2, the apparatus for treating substrates 1 comprises a number of chambers 10, 22, 24, 30, cleaning units 100 and 200 and a moving unit 300. Each chamber 10, 22, 24, 30 provides space where the process is performed. The moving unit 300 moves the substrate S to one direction between the chambers 10, 22, 24, 30 and within the chambers 10, 22, 24, 30. The cleaning unit 100 and 200 cleans the substrate S which is being moved by the moving unit 300 in the chambers. The components disclosed above will now be described below in detail.

Each chamber 10, 22, 24, 30 has a rectangular shape of which the inside is hollow. The chambers 10, 22, 24, 30 are disposed in a straight line. Inlets12 are provided on one side of each chamber 10, 22, 24, 30, and outlets 14 are provided on the opposite side. The substrate S goes into the chamber 10, 22, 24, 30 through the inlets 12 and goes out the chamber 10, 22, 24, 30 through the outlets 14. The substrate S is moved sequentially from the very front chamber to the last chamber. The designated process is performed to the substrate S in each chamber 10, 22, 24, 30. The cleaning process is performed in at least one of the chambers 22, 24 among the chambers 10, 22, 24, 30. A chamber 10 where etching process is performed is located in front of the chambers 22 and 24 where cleaning process is performed, and A chamber 30 where drying process is performed is located in rear of the chambers 22 and 24 where cleaning process is performed,

Moving unit 300 is disposed within each chamber 10, 22, 24, 30. The moving unit 300 includes a number of shafts 320, rollers 340, and drive part 360. The shafts 320 are disposed parallel to each other within each chamber 10, 22, 24, 30. The shafts 320 are provided from portion of chamber close to the inlets 12 to the portion of chamber close to the outlets. Each shaft 320 has multiple rollers 340 disposed along its length and the multiple rollers 340 are fixedly coupled to each of the shafts 320. The shafts 320 are rotated around their central axes by the drive part 360. The drive part 360 includes pulleys 261, belts 364 and motors 366. The pulleys 362 are each coupled to opposite ends of each shaft. The pulleys 362 coupled to each different shaft 320 and disposed adjacent to each other are connected to each other by the belt 364. The shafts 320 and the rollers 340 are rotated by the combination of pulleys 362, belts 364 and motors 366. The substrate S is moved in a straight line along the shafts 320 with the bottom surface of the substrate contacting the roller. Each shaft 320 is disposed horizontally to be moved at level. Alternatively, one end and the other end of each shaft 320 may be provided at different levels to be moved at a slope.

According to an embodiment, the first cleaning chamber 22, the second cleaning chamber 24, and a drying chamber 30 are sequentially disposed in a straight line. The cleaning unit is installed in the first cleaning chamber 22 and the second cleaning chamber 24. The cleaning unit provided in the first cleaning chamber 22 includes a steam cleaning member 100 and a brush cleaning member 200. The cleaning unit provided in the second cleaning chamber 24 includes a dual fluid supply nozzle 24a.

The substrate S is cleaned while passing the first cleaning chamber 22 and the second cleaning chamber 24, then it is moved to the drying chamber 30 to be dried. The steam cleaning member 100 injects high temperature and high-pressured steam onto the substrate S to initially clean the substrate S. Impurities such as particles adhered to the substrate S by steam are removed from the substrate S or the adhesion of impurities is weakened. The brush cleaning member 200 secondarily cleans the region on the substrate S which has been cleaned by steam, by using physical contact force. The impurities still remaining on the substrate are removed from the substrate S by the brush 220. The adhesion to the substrate S of the particles sized under few micrometers is weakened by steam cleaning. Then the particles are removed from the substrate S by cleaning by brush.

The dual fluid supply nozzle 30a removes from the substrate S, the remaining particles from the first cleaning chamber 22 and the remaining particles on, or in the substrate S still unremoved from brush 220. The dual fluid supply nozzle 20a has a structure that can inject the vaporized deionized water onto the substrate S after providing high-pressured gas to make deionized water to a vapor state. A slit nozzle having a long length may be used as the dual fluid supply nozzle 30a.

The drying nozzle 30a providing drying gas to the substrate S is disposed on the drying chamber 30. The drying nozzle 30a provides heated air, heated nitrogen gas, or heated inert gas to dry the substrate S. Alternatively, the drying nozzle 30a may dry the substrate S by providing organic solvent such as isopropyl alcohol to the substrate S. Then the above heated air may be provided to the substrate S to dry it. A slit nozzle having a long length may be used as the drying nozzle 30a.

The steam cleaning member 100 includes a steam nozzle 120a and a steam generator 120b. The steam nozzle 120a is provided in the first cleaning chamber 22. The steam nozzle 120a injects steam generated from the steam generator 120b onto the substrate S. According to an embodiment, the steam nozzle 120a has a long rod shape. In case the substrate S is generally rectangular, the substrate S has a first side S1 and a second side S2 vertical to the first side S1. The first side S1 is vertical to the direction the substrate S is moved (i.e. lengthwise of the shaft), and the second side S2 is parallel to the direction the substrate S is moved (i.e. direction of array of the shafts 320). The steam nozzle 120a is provided with a length corresponding to the first side S1 of the substrate S. Also, in case the substrate S is generally in a disc shape, the steam nozzle 120a is provided with a length corresponding to the diameter of the substrate S. The steam nozzle 120a is disposed on top of the substrate S parallel to the lengthwise of the shaft 320. The detailed structure of the steam generator 120b will be disclosed hereafter.

The brush cleaning member 200 includes a brush 220, rotational axis 240, and a motor 260. The brush 220 removes impurities from the substrate S by contacting physically with the substrate S. The rotational axis 240 is fixedly coupled to the brush 220. The rotational axis 240 is coupled with the motor 260 to rotate the brush 220. The brush 220 is provided in a length corresponding to the first side S1 of the substrate S. The brush 220 is respectively disposed on the top and bottom of the substrate S parallel to lengthwise of the shaft 320 within the first cleaning chamber 22.

The steam nozzle 120a is disposed in the front of the brush 220 to be cleaned secondarily by the brush 220 after being initially cleaned by steam. The substrate S is continuously moved in one direction while the process is performed. Also, the region on the substrate S having been cleaned by steam is then cleaned by the brush 220.

In the above disclosed embodiment, the steam nozzle 120a is provided on top of the substrate S. However, the steam nozzle 120a may be provided on the bottom of the substrate S or be provided on both the top and bottom of the substrate S. In the above disclosed embodiment, the brush 220 is provided on both the top and bottom of the substrate S. However, the brush 220 may be provided only on the top or the bottom of the substrate S, which is provided in the same location where the steam nozzle 120a is provided.

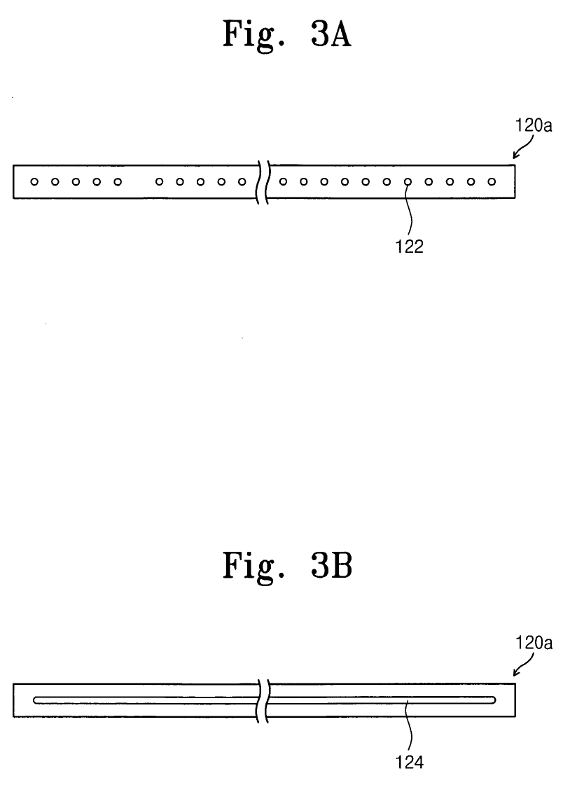

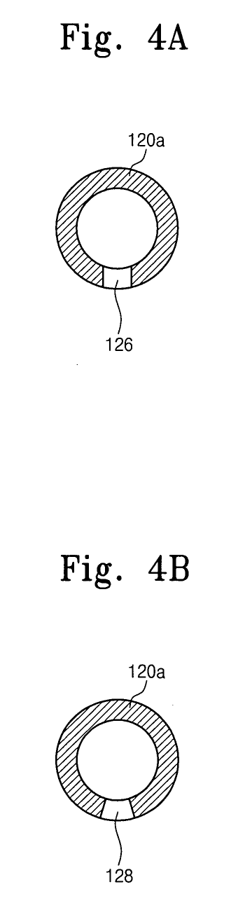

FIG. 3a and FIG. 3b respectively illustrate various examples of the inject holes 122 and 124 provided in the steam nozzle 120a. The inject holes 122 provided in the steam nozzle 120a may be provided in a plurality of circular holes as shown in FIG. 3a. The size of circular holes and the spaces between the adjacent circular holes which are formed lengthwise at the steam nozzle 120a, may be set differently so that even quantity of steam may be injected in general. Alternatively, the inject holes 124 provided in the steam nozzle 120a may be provided in long slit shape as shown in FIG. 3b. Also, as shown in FIG. 4a, the inject hole 126 may be provided so that the hole width is even or the hole width is outwardly gradually narrow along the direction the steam is injected. Alternatively as shown in FIG. 4b, the inject hole 126 may be provided so that the hole width is outwardly gradually wide along the direction the steam is injected. When a steam nozzle 120a is used, as shown in FIG. 4a, steam may be injected in high pressure onto the substrate S. When a steam nozzle 120a is used, as shown in FIG. 4b, steam may be wider in width when injected onto the substrate S.

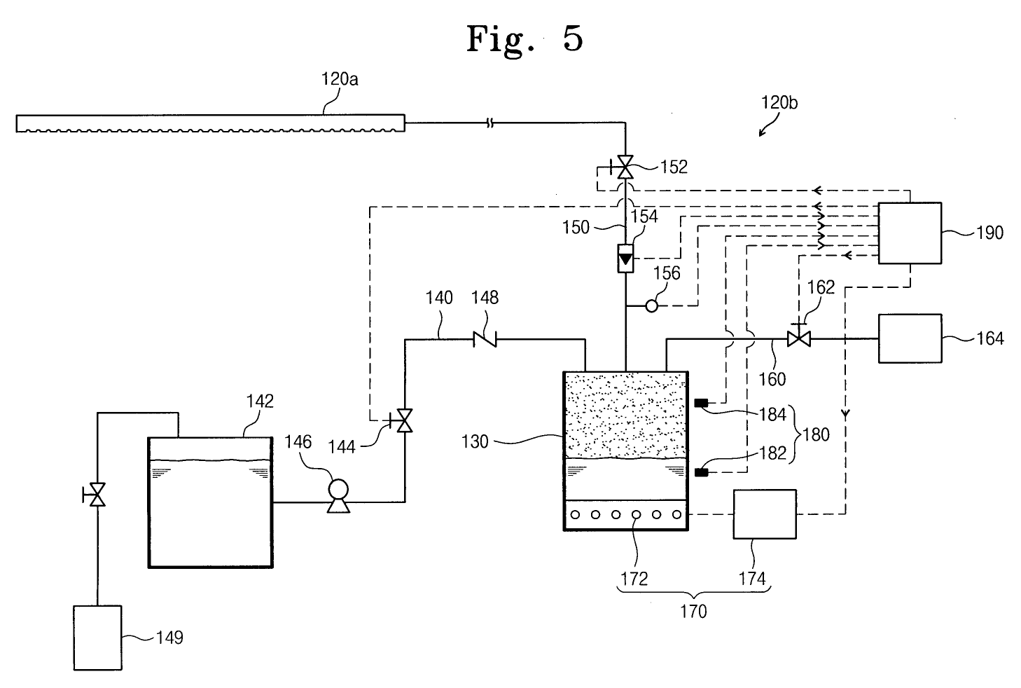

FIG. 5 illustrates an embodiment of the steam generator 120b. Referring to FIG. 5, the steam generator 120b includes a housing 130, liquid supply pipe 140, a steam supply pipe 150, a gas supply pipe 160, a heater 170, and a controller 190. The housing 130 has a box shape where a space for the steam to be generated is provided and is made airtight from exterior. A level detector 180 is installed in the housing 130, which detects whether the cleaning liquid filled inside has reached a designated location. It is preferable that the cleaning liquid is filled in the housing 130 over a designated level (hereafter, bottom designated level) so that the steam may be generated continuously. Also, it is preferable that the cleaning liquid is filled in the housing 130 below a designated level (hereafter, top designated level) so that a space for the generated steam is provided. The level detector 180 detects the level of the cleaning liquid filled in the chamber 130. According to an embodiment, the level detector 180 includes a first detector 182 detecting whether the cleaning liquid has reached the bottom designated level, and a second detector 184 detecting whether the cleaning liquid has reached the top designated level.

The heater 170 heats the cleaning liquid within the housing 130 to generate steam from the cleaning liquid. The heater 170 heats the cleaning liquid by using fuel or electricity. The heating is efficient when the heating is done by using fuel. Continuous heating is possible without supplementing fuel when heating is done by using electricity. The heater 170 is installed on the bottom surface of the housing 130. When heating by electricity, the heater 170 includes hot wires 172 and a power source 174 supplying energy to the hot wires 172.

The liquid supply pipe 140 supplies cleaning liquid from the liquid storage 149 disposed on the outside to the housing 130. The liquid supply pipe 140 may be connected to the top surface of the housing 130. Deionized water or pure water may be used for the cleaning liquid. In the liquid supply pipe 140, a valve 144 is installed for opening and shutting the internal passage or adjusting the flow-rate. A valve adjustable by the electrical signals is used as the valve 144. A pump 146 is installed in the liquid supply pipe 140 to provide hydraulic pressure to the cleaning liquid flowing inside the liquid supply pipe 140. A buffer tank 142 may be installed in between the liquid storage 149 and the pump 146, storing the cleaning liquid temporarily. Also, in the liquid supply pipe 140 a reverse-flow preventing member 148 such as check valve is provided to prevent reverse flow of steam into the liquid supply pipe 140.

The steam supply pipe 150 supplies the steam generated in the housing 130 to the steam nozzle 120a. The steam supply pipe 150 is connected to the top surface of the housing 130. In the steam supply pipe 150, a switch valve 152 opening and closing its inside passage, a flow-meter 154 measuring the steam flow rate flowing inside, and a pressure gauge 156 measuring its inside pressure are installed. Also, a flow rate adjusting valve (not shown in drawings) may be installed in the steam supply pipe 150. The pressure within the housing 130 is very high due to steam generation in the housing 130. The steam may be supplied to the steam nozzle 130a by the pressure generated from the housing 130. Alternatively, a gas supply pipe 160 may be connected to the housing 130. The gas supply pipe 160 supplies gas to the housing 130 to increase the pressure of the steam provided through the liquid supply pipe 140. Chemically stable gas such as nitrogen gas or inert gas is used as the gas. The quantity of gas supplied through the gas supply pipe 160 may be adjusted according to the amount of pressure or flow-rate of the steam provided through the steam supply pipe 150.

The controller 190 controls the performing of the steam generator 120b. The controller 190 receives measured signal from the level detector 180, pressure gauge 156 and the flow-meter 154. The controller 190 controls the pump 146, the valve 144 installed in the liquid supply pipe 140, the power source 174 of the heater 170, the valve 152 installed in the steam supply pipe 150, and the valve 162 installed in the gas supply pipe 160.

For example, when the first detector 182 detects that the level of the cleaning liquid within the housing 130 has reached the bottom designated level, the controller 190 opens the valve installed in the liquid supply pipe 140 to provide deionized water to the liquid supply pipe 140. The controller 190 controls outputting of the pump 146 so that the cleaning liquid may be provided to the housing 130 in a pressure higher than the pressure within the housing 130. Also, when the second detector 184 detects that the level in the housing 130 has reached the top designated level, the controller 190 closes the valve 144 installed in the liquid supply pipe 140 to stop the deionized water to be provided to the liquid supply pipe 140. By the mentioned performing of the controller 190, the cleaning liquid in the housing 130 is filled within the set scope, and the steam may be continuously provided to the steam nozzle 120a while the process is being performed.

When the flow-meter 154 or the pressure gauge156 detects that the flow rate or pressure of the steam which are supplied through the steam supply pipe 150 overflow set scope, the controller 190 controls the power source174 and the valve 162 installed in the gas supply pipe 160 to control a power magnitude supplied to the hot wires 172 and the gas quantity supplied to the housing 130. For example, in case the steam flow is small, power magnitude supplied to the hot wires may be increased in order to increase the steam quantity generated in the housing 130. In case a pressure of the steam is low, gas quantity supplied to the housing 130 may be increased.

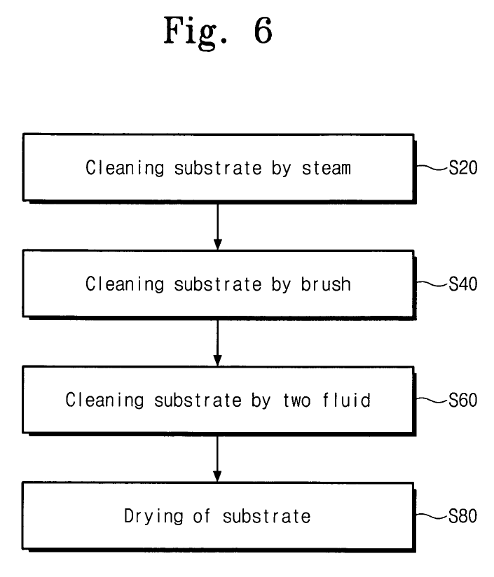

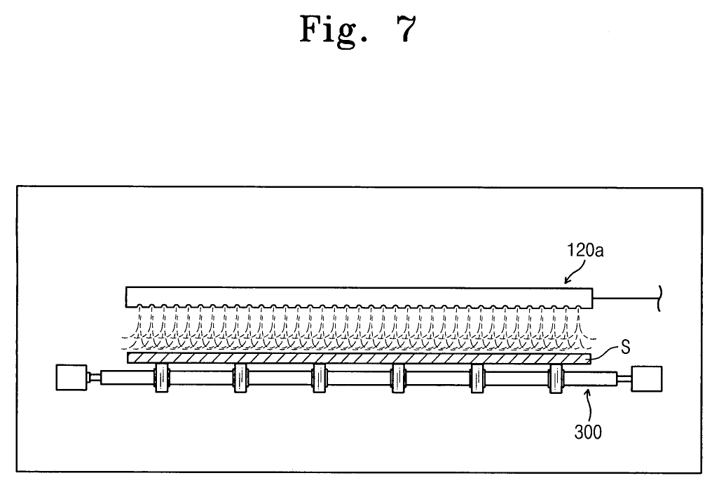

Method of treating substrate S is sequentially described below with reference to FIG. 6. The substrate S is transferred to the first cleaning chamber 22. Deionized water in high temperature and high pressure state is injected while the substrate S is being transferred (Step S20). FIG. 7 shows briefly the steam that is injected onto the substrate S. The region on the substrate S which cleaning is done by steam is then cleaned by brush 220 (Step S40). The substrate S is transferred to the second cleaning chamber 24. deionized water in spray state is injected from the second cleaning chamber 24 to the substrate S so that the substrate S is cleaned again (Step S60). The substrate S is transferred to the drying chamber 30 when cleaning is finished. In the drying chamber 30, deionized water remaining on the substrate S is removed from the substrate S by isopropyl alcohol or drying gas (Step S80).

Conventionally, when cleaning the substrate S by directly applying deionized water in a liquid state, deionized water is consumed in large quantity for cleaning of large substrates. For example, in case the substrate S is a substrate used in fabricating the 7^{th} generation flat panel display, it is approximately 1,870×2,200 mm in size and Deinoized water consumed is approximately 100 to 140 liters in quantity. However, when cleaning the substrate S by directly supplying water in a steam state to it, deionized water consumed is approximately 0.6 to 3 liters per minute. Therefore quantity of cleaning liquid used in process may be decreased according to the present invention.

Also, when cleaning the substrate S by directly supplying deionized water to it, there is limit in raising deionized water temperature or deionized water supply pressure due to capacity limit in heater and/or pump. However when cleaning the substrate S by supplying deionized water in steam state to the substrate S, it is possible to inject steam in high temperature and/or high pressure. This not only improves removing of particles from the substrate S but also diminishes time spent in cleaning the substrate S. When actually performing cleaning process by using steam, the steam is provided in approximately between 100 to 200 Celsius degrees (° C.) and 1 to 15 kg/cm² in pressure. However as needed, steam may be provided in a higher temperature and/or in a higher pressure in scopes that do not affect the substrate S.

Also, when cleaning the substrate S by supplying vaporized deionized water directly to it, particles of fine size cannot be removed from the substrate S easily. However, as shown in FIG. 1, when the steam cleaning member 100 and the brush cleaning member 200 are sequentially disposed to perform cleaning process, adhesion of fine particles under approximately 0.3 μm is weakened from the substrate S by steam cleaning. Then the particles are easily removed from the substrate S by the brush 220.

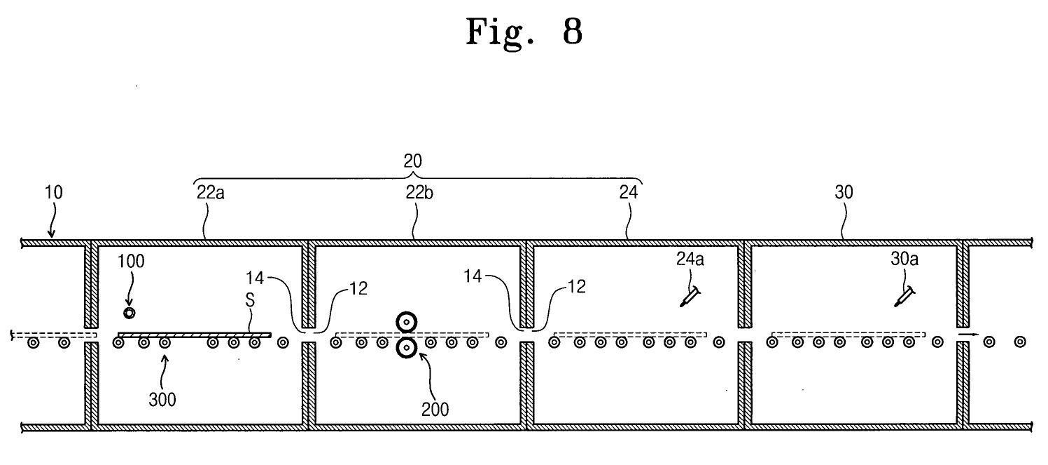

In the apparatus for treating substrates 1 of FIG. 1, the steam cleaning member 100 and the brush cleaning member 200 are provided in a single cleaning chamber 22. However, as shown in FIG. 8, the steam cleaning member 100 and the brush cleaning member 200 may be provided in separate cleaning chamber 22 and 23. The cleaning chamber 22a which the steam cleaning member 100 is provided is disposed in front of the cleaning chamber 23 which the brush cleaning member 200b is installed. This is done so that cleaning by the brush 200 may be performed immediately after steam cleaning of the substrate S is performed.

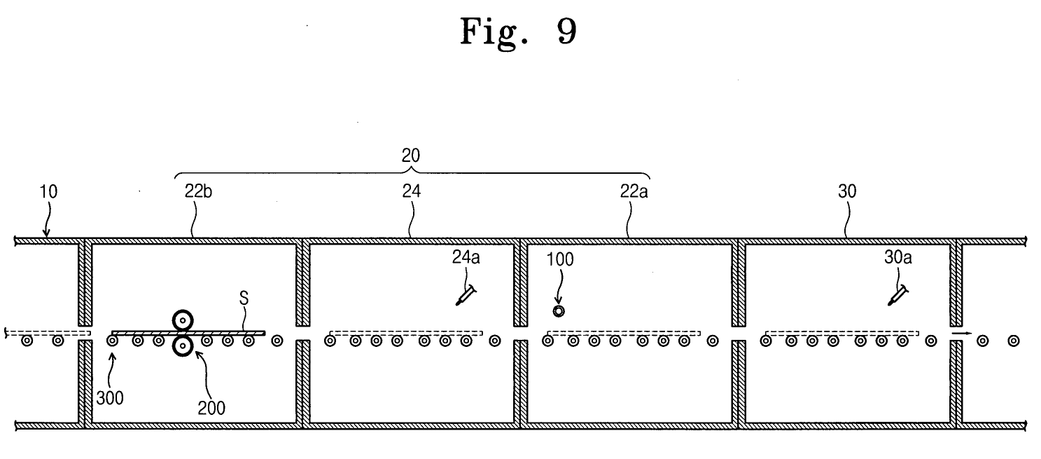

Also, in the disclosed embodiments, the steam cleaning member 100 is disposed so that the steam cleaning of the substrate S may be done immediately before cleaning by brush is performed. However, steam cleaning may be performed in different sequence. For example, as shown in FIG. 9, the cleaning chamber 22a which the steam cleaning member 100 is provided may be disposed so that steam cleaning of the substrate S may be done before cleaning and drying by other cleaning members is performed. The substrate S may be dried somewhat during steam cleaning because steam cleaning is performed in high temperature.

In the disclosed embodiments, the steam cleaning member 100 is provided within the device where a series of process is performed continuously. However, only an independent cleaning chamber with a steam cleaning member 100 may be provided so that only steam cleaning for the substrate S may be performed. In this case, the substrate S is fixed and the nozzle injecting steam may be moved front to back, during the process is performed.

Cleaning of substrate may be performed effectively according to the present invention.

In the present invention, as deionized water is injected to the substrate in steam state, deionized water may be injected to the substrate in high temperature and high pressure.

Also in the present invention, fine-sized impurities may be removed from the substrate.

Lastly, according to the present invention, quantity of deionized water used for cleaning the substrates may be decreased.

What is claimed is:

1. An apparatus for treating substrates comprising:
a chamber having a space in which process is performed and substrate is accommodated; and
a steam cleaning member for supplying steam to a substrate disposed inside the chamber to clean the substrate,
wherein the steam cleaning member comprises:
a steam generator for generating steam from cleaning liquid;
a steam nozzle provided to the chamber, to directly inject the steam generated from the steam generator to the substrate.

2. The apparatus of claim 1 wherein,
the substrate has a rectangular shape; and
the steam nozzle is provided in a length to inject steam, the length being corresponding to a first side of the substrate,
further comprising a moving unit moving in a straight line the steam nozzle or the substrate in a direction parallel to the second side vertical to the first side.

3. The apparatus of claim 1 further comprising:
a moving unit provided to the chamber, to move the substrate in a straight line wherein the moving unit comprises:
rotative shafts juxtaposed in the moving direction of the substrate; and
rollers contacting the substrate, the rollers being disposed on outer surface of the shafts to rotate with the shaft, respectively; and
wherein the steam nozzle is disposed in a vertical direction to the moving direction of the substrate.

4. The apparatus of claim 1 wherein,
the substrate has a disc shape;
the steam nozzle is provided with a length to inject steam, the length being corresponding to diameter of the substrate; and
further comprising a moving unit for moving the steam nozzle or the substrate in a straight line.

5. The apparatus of claim 1 wherein,
the steam nozzle has a rod shape, and a slit or a plurality of circular holes are formed lengthwise at the steam nozzle.

6. The apparatus of claim 1 wherein, the steam generator comprises:
a housing in which a space is provided for receiving cleaning liquid;
a liquid supply pipe configured to supply cleaning liquid to the housing;
a heater for heating the cleaning liquid provided in a space of the housing; and
a steam supply pipe configured to supply steam generated in the space of the housing to the steam nozzle.

7. The apparatus of claim 6 wherein,
the steam generator further comprises a gas supply pipe configured to supply pressurized gas to the space in the housing such that a hydraulic pressure is applied to the steam generated within the housing.

8. The apparatus of claim 7, wherein the steam generator comprise:
the steam generator comprises a pressure gauge for measuring an inner pressure of the steam supply pipe; and
a controller for controlling a flow controller installed at the gas supply pipe, the controller receiving a measured signal from the pressure gauge to enable the inner pressure of the steam supply pipe to be maintained within a set scope during a process.

9. The apparatus of claim 7 wherein the steam generator comprises:
a pump installed at the liquid supply pipe, to apply a hydraulic pressure to the cleaning liquid supplied into the housing;
a level detector for detecting the level of the cleaning liquid filled in space of the housing;
a controller for controlling the valve and/or the pump installed at the liquid supply pipe, the controller receiving a detected signal from the level detector to enable the level to be maintained within a set scope during a process.

10. The apparatus of claim 6 wherein,
the steam generator further comprises a reverse-flow preventing member installed at the liquid supply pipe for preventing the steam in the housing from flowing reversely to the liquid supply pipe.

11. An apparatus for treating substrates comprising:
a moving unit moving substrates in a straight line;
a cleaning unit configured to clean substrates being moved by the moving unit, wherein the cleaning unit comprises:
a steam cleaning member having steam nozzle configured to supply steam to the substrate, the steam cleaning member configured to clean the substrate by steam;
a brush cleaning member having a brush configured to clean the region on the substrate where steam cleaning has been performed.

12. The apparatus of claim 11 wherein,
the device further comprises a chamber where cleaning process is performed, the chamber of which the steam nozzle and the brush are disposed,
wherein the moving unit comprises:
rotative shafts disposed in the chamber, the rotative shafts disposed parallel to the moving direction of the substrate;
rollers contacting the substrate, the rollers being disposed on surface of the shafts to rotate with the shaft, respectively; and,
wherein the steam nozzle is provided in a length to inject steam, the length being corresponding to a side of the substrate, and the steam nozzle is disposed vertical to the moving direction of the substrate.

13. The apparatus of claim 11 wherein the steam generator comprises:
a housing having space where cleaning liquid is provided;
a liquid supply pipe where cleaning liquid is supplied to the housing;
a heater for heating the cleaning liquid provided in the space of the housing; and
a steam supply pipe providing steam generated within the space of the housing to the steam nozzle.

14. The apparatus of claim 13 wherein the steam generator further comprises:
a gas supply pipe providing pressurized gas to space in the housing to provide hydraulic pressure to the steam generated within the housing.

15. The apparatus of claim 14 wherein the steam generator further comprises:
a pressure gauge measuring pressure in the steam supply pipe;
a controller controlling a flow controller installed in the gas supply pipe by having signal authorized which the signal is measured in the pressure gauge so that the pressure in the steam supply pipe is maintained within set scope during a process.

16. The apparatus of claim 14 wherein the steam generator further comprises:
a pump disposed in the liquid supply pipe, the pump applying hydraulic pressure to the cleaning liquid supplied to the housing;
a level detector detecting the level of the cleaning liquid filled in space of the housing;
a controller controlling the valve and/or the pump disposed in the liquid supply pipe by having signal authorized which the signal is measured in the pressure gauge so that the pressure in the steam supply pipe is maintained within set scope during a process.

17. The apparatus of claim 6 wherein,
the steam generator is disposed in the liquid supply pipe and, the steam generator further comprises a reverse-flow preventing member preventing reverse-flow of the steam to the liquid supply pipe in the housing.

18. A method for treating substrates wherein,
a steam nozzle is disposed on top or bottom of the substrate, the steam nozzle configured to inject steam directly to the substrate in a length corresponding to a side of the substrate, and
the substrate or the steam nozzle is moved in a straight line so that cleaning may be performed from first line to other lines successively in the substrate.

19. The methods of claim 18 wherein,
water is provided into the housing where the housing is heated to generate steam to be provided to the steam nozzle, and
the quantity of pressurized gas provided to the housing is adjusted to adjust the inject pressure of the injected steam.

20. The methods of claim 18 wherein,
cleaning by brush is done immediately after cleaning by the steam is performed to the substrate.

21. The methods of claim 18 wherein,
drying is done immediately after cleaning by the steam is performed to the substrate.

22. A method for treating substrates wherein,
steam is injected onto the substrate to weaken adhesion of impurities on the substrates which the impurities are removed from the substrate by using brush.

23. The method of claim 22 wherein,
the steam nozzle configured to inject steam to the substrate has a length that may inject steam in a length corresponding to a side of the substrate, the brush has a length corresponding to a side of the substrate,
the substrate moves in a straight line, and the steam nozzle and the brush are disposed vertically from the moving direction of the substrate.
